(19) United States
(12) Patent Application Publication
(10) Pub. No.: US 2004/0103204 A1
(43) Pub. Date: May 27, 2004

(54) Method of connecting a client device with a router in a wireless communication network

(75) Inventor: Alper E. Yegin, Foster City, CA (US)

Correspondence Address: Dean E. McConnell, Brinks Hofer Gilson & Lione, Suite 1600, One Indiana Square, Indianapolis, IN, 46204, US

(73) Assignee: DoCoMo Communications Laboratories USA, Inc.

(21) Appl. No.: 10/306,299

(22) Filed: Nov. 27, 2002

(51) Int. Cl. G06F 15/16

(52) U.S. Cl. 709/229; 709/250

(57) ABSTRACT

A method of connecting a client device with a router in a wireless communication network is disclosed. The method comprises the steps of establishing a link layer connection with a first access point with a first wireless network interface; detecting a second access point with a second wireless network interface; establishing a link layer connection with a second access point with a first wireless network interface; and determining the compatibility between the client device with an access router associated with the second access point.

### FIELD OF THE INVENTION

This invention relates generally to wireless communication devices and networks, and in particular, to a method of connecting a client device with an access router in a wireless communication network.

### BACKGROUND OF THE INVENTION

Access points and access routers are the basic building blocks of wireless access networks. Access points (AP) provide a radio interface to a network by bridging wired segments to wireless segments. The access router (AR) behind the AP provides gateway functionality for the internet protocol (IP) network. Client hosts establish radio links with an AP to communicate with the AR and access the IP network.

In order to connect to the Internet, a client device first has to discover access points in its neighborhood. It might have to do this when it first starts, or when it loses its current network connection due to deteriorating radio conditions. The client device can perform access point discovery by scanning different radio channels. Since there may or may not be any access point on a given channel, this process is usually executed in an exhaustive manner. Depending on the availability of access points and their responsiveness, this process of identifying a next access point can take up to several hundreds of milliseconds with IEEE 802.11b technology, for example.

Once an access point is discovered, the client now has to establish link-layer connectivity with this access point in order to be able to exchange IP packets with the access router. Unless this is an open system (i.e., free network access), this stage involves authentication and authorization of the client. Authentication process usually requires several over-the-air messages accompanied with others over the wired backbone for the access point communicating with the authentication backend server. Because the latter usually involves messaging across the Internet, it is a very costly operation. A successful authentication process can take up to a few seconds to complete.

Once the client has link-layer connectivity, it can proceed to discovering the access router(s) on this link and configure its IP address and default gateway. Depending on the choice of address configuration (e.g., via PPP, DHCP, IPv6 stateless address auto-configuration), this stage can take between tens of milliseconds and a couple of seconds.

Depending on the needs of the client, there can be more stages of discovery, such as, discovering a DNS server, localized mobility management server, IPv4-IPv6 translators or application layer gateways. Any of these operations would have to wait for successful completion of the earlier stages, and therefore cannot be executed in parallel.

When a client desires to get connected to the Internet via an access network, it has to follow a number of stages before it can successfully do so. Going through this complete connection process usually takes on the order of few seconds, during which the client has no IP connection. While being disruptive to any kind of communication, this type of latency is especially unacceptable for delay-sensitive real-time applications, such as voice over IP (VoIP).

The problem becomes magnified when there are several access networks with varying capabilities in the same geography. This type of heterogeneity would exist with WLAN deployments. Each access point might be owned by a different service provider that may or may not allow a particular client in their network. Even after a client has established link-layer connectivity with one of the access points, it might discover that the access router doesn't provide a certain required functionality (e.g., no IPv6 support), or the network is lacking a desired server/service (e.g., SLP). In this case, even though the client has already spent its valuable time trying to use a particular access network, now it might have to start from the beginning and look for another access point. This process also needs to be repeated each time the client has to perform a handover.

Accordingly, there is a need for a method of and apparatus for connecting a client device with an access router in a wireless communication network.

### SUMMARY OF THE INVENTION

A method of connecting a client device with a router in a wireless communication network is disclosed. The method comprises the steps of establishing a link layer connection with a first access point by way of a first wireless network interface; detecting a second access point with a second wireless network interface; establishing a link layer connection with a second access point by way of the second wireless network interface; and determining the compatibility between the client device and an access router associated with the second access point.

### BRIEF DESCRIPTION OF THE DRAWINGS

FIG. 1 is a block diagram of a conventional wireless communication network;

FIG. 2 is a block diagram of system incorporating a method and apparatus according to the present invention;

FIG. 3 is a block diagram of a client device according to the present invention;

FIG. 4 is a block diagram of a management unit according to the present invention;

FIG. 5 is a flowchart showing a method of connecting a client device with a router in a wireless communication network according to the present invention;

FIG. 6 is a more detailed flowchart showing a method of connecting a client device with a router in a wireless communication network according to the present invention; and

FIG. 7 is a flowchart showing a method of saving power in a client device according to the present invention.

### DETAILED DESCRIPTION OF THE DRAWINGS

Turning now to FIG. 1, a block diagram of a conventional wireless communication network is shown. A client host 102 is coupled to an access point 104 by a wireless communication link 106. The access point 104 is coupled to an access router 108 by a communication link 110. The access router 108 is coupled to a communication network, such as the Internet 112.

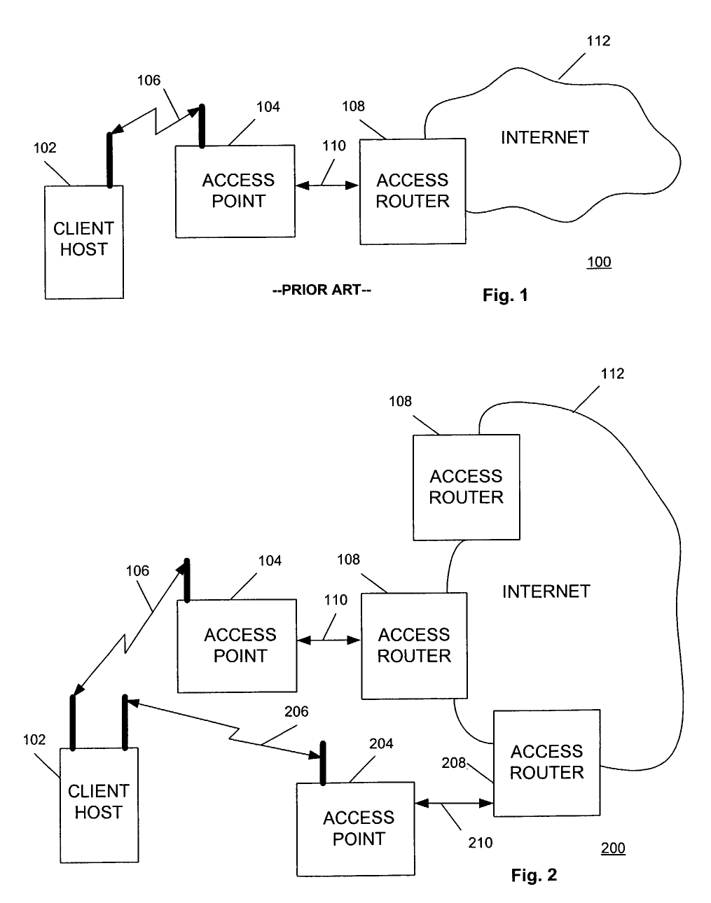

Turning now to FIG. 2, a block diagram of system incorporating a method and apparatus according to the present invention is shown. In particular, a client device 202 having multiple communication interfaces, in addition to communicating with access point 104, can communicate with a second access point, such as access point 204 by way of a wireless communication link 206. The second access point 204 could also communicate with a separate access router 208 by way of a communication link 210. The client host 202 having multiple network communication interfaces can both send and receive data on one network interface, while determining the availability and compatibility of a second access point and possibly access router.

The client device 202 enables the access network discovery process could be carried out in parallel with exchanging data traffic. Client devices that have only one transceiver unit can do either data exchange or discovery at a time, but not both. Interleaving these two operations jeopardizes the performance of both and therefore is impractical. These problems can be solved by using dual-transceivers on the client device of the present invention.

A client device can either have two separate wireless network interfaces (e.g. two separate transceivers), or have one interface that has two transceivers (e.g. a single network card having two transceivers). In either case, the client device is able to establish link-layer and network-layer connectivity using both units simultaneously. While one interface is used for sending and receiving data traffic, the other can be used for discovering other access networks.

The client device can either activate a discovery transceiver only when it detects the current radio link with a data transceiver is deteriorating and a link-layer handover is anticipated, or keep it in discovery stage all the time. The former choice has better battery consumption where the discovery transceiver can run in power-saving mode until it is needed, as will be described in more detail in reference to FIG. 7. The latter choice constantly keeps track of candidate APs in the vicinity and therefore reacts to requests even faster.

Turning now to FIG. 3, a block diagram of a client device 102 according to the present invention is shown. The device preferably includes a control circuit 302, such as a microprocessor, microcontroller, ASIC or some other circuit or integrated circuit to control the device. A memory device 303 could also be coupled to the control circuit. The control circuitry 302 is also coupled to a first transceiver 304 having an antenna 306, and a second transceiver 308 have an antenna 310. The client device could also include a local wireless transceiver 312 for enabling low-power communications, such as infrared, Bluetooth, IEEE 802.11, etc. The client device can also include a communication port 314 for enabling wired communications such as RS-232 communication. The client device also preferably includes a GPS unit 316 enabling the reception of GPS signals. The control circuit 302 is also coupled to a user interface section 324 which preferably comprises a user interface 330, a display 332, audio circuitry 334 having a microphone to 336 and/or a speaker 338. The client device could be any type of wireless communication device, such as a wireless PDA or a cellular telephone.

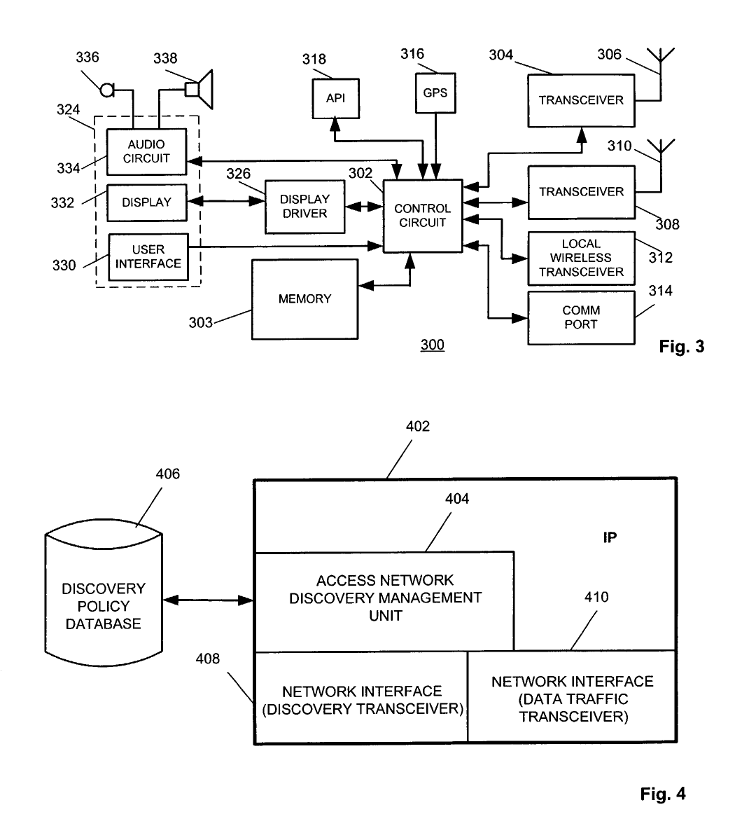

Turning now to FIG. 4, a block diagram of a management unit according to the present invention is shown. Whenever a discovery transceiver is asked to discover an access network, it goes over the complete discovery cycle as described earlier. Once it finds an access point that it can establish a link-layer and network-layer connection, followed by the configuration and discovery of desired parameters and services, it can signal the successful operation to a management unit 402.

The management unit could be implemented in control circuit 302 and memory 303, for example, and determines when to switch from the current access point to the next access point. Usually, as soon as the connection to the next access point is set up properly, the management unit 402 can migrate its IP session from one transceiver to the other, and tear-down its current radio link. The discovery transceiver now assumes the role of handling data traffic, and the other transceiver becomes discovery transceiver. By alternating in this fashion, each transceiver assumes different roles at different times.

An Access network discovery management unit (ANDMU) 404 consults with a discovery policy database (DPD) 406 to ensure a newly discovered access point is appropriate before IP connectivity is switched. Finally, a network interface 408 and a network interface 410 enable communication by one transceiver as a discovery transceiver or another transceiver as a data communication transceiver.

The discovery policy database 406 preferably includes authentication requirements along with required authentication parameters. The ANDMU 404 has to make sure security requirements are met (e.g., correct SSID is advertised by the access point, access point provides mutual authentication methods, etc.), and it can get the client authenticated and authorized with the access point. The discovery policy database also preferably includes the protocol supports required, such as whether client requires IPv4, IPv6, DNS, Mobile IPv4, Fast Handovers for Mobile IPv4, Fast Handovers for Mobile IPv6, Localized Mobility Management, etc. support from the access network. The ANDMU 404 has to verify each one of these based on the configuration stated in the DPD 406. It would preferably switch the interface only after all of these requirements are satisfied. The discovery policy can be stored in the discovery policy database in the form of a logical expression, such as:

(authentication not required) and

((IPv4 and Mobile IPv,4 supported) or (IPv6 supported)).

In this example, ANDMU will have to find an access point that doesn't require client authentication. It also has to verify that the access network either provides IPv4 support with a Mobile IPv4 foreign agent, or IPv6 support.

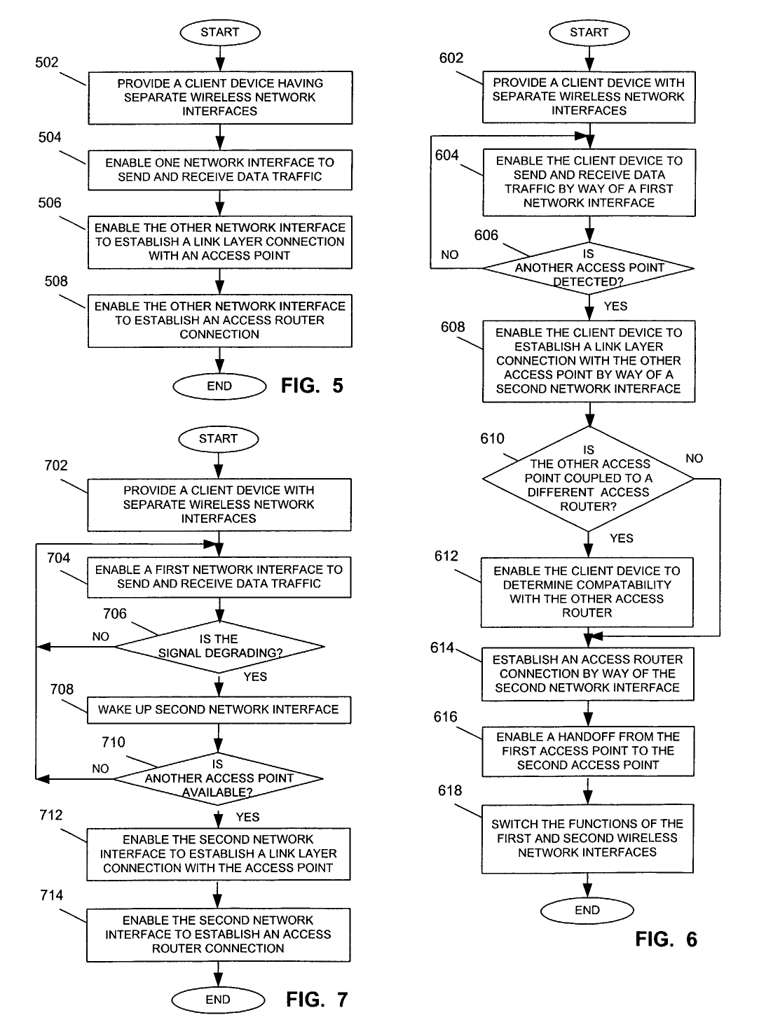

Turning now to FIG. 5, a flowchart shows a method of connecting a client device with a router in a wireless communication network according to the present invention. In particular, a client device having separate wireless network interfaces is provided at a step 502. The separate wireless network interfaces could comprise, for example, separate transceivers as shown in FIG. 3. One network interface is then able to send and receive data traffic at a step 504. The second network interface is able to establish a link layer connection with an access point at a step 506. The second network interface is also able to establish an access router connection at a step 508.

Turning now to FIG. 6, a more detailed flowchart shows a method of connecting a client device with a router in a wireless communication network according to the present invention. In particular, a client device having separate wireless network interfaces is provided at a step 602. The client device is able to send and receive data traffic by way of a first wireless network interface at a step 604. It is then determined whether another access point is detected at a step 606. If so, the client devices able to establish a link layer connection with the other access point by way of a second wireless network interface at a step 608. It is then determined whether the other access point is coupled to a different access router in a step 610. If so, the client devices then able to determine compatibility with the other access router at a step 612. An access router connection is established by way of the second network interface a step 614. A handoff from the first access point to the second access point is then performed a step 616. Finally, the functions of the first and second wireless access network interfaces are switched at a step 618. That is, the second wireless network interface now sends and receives data traffic, while the first wireless network interface detects and establishes a connection with a separate access point, as necessary.

Turning now to FIG. 7, a flowchart shows a method of saving power in a client device according to the present invention. In particular, the client device is provided with separate wireless network interfaces at a step 702. One network interfaces been able to send and receive data traffic at a step 704. It is then determine whether a signal is degrading at a step 706. If so, the second wireless network interfaces then woken up a step 708. That is, in order to preserve power, the second wireless interface is in a sleep mode until it is needed. It is then determine whether another access point is available at a step 710. If so, the second network access interface establishes a link layer connection with the access point at a step 712. Finally, the second network interface establishes an access router connection at a step 714.

It can therefore be appreciated that the new and novel method and system for connecting a client device with an access router in a wireless communication network has been described. It will be appreciated by those skilled in the art that, given the teaching herein, numerous alternatives and equivalents will be seen to exist which incorporate the disclosed invention. As a result, the invention is not to be limited by the foregoing embodiments, but only by the following claims.

1. A method of connecting a client device with a router in a wireless communication network, the method comprising the steps of:
establishing a link layer connection with a first access point by way of a first wireless network interface;
detecting a second access point with a second wireless network interface;
establishing a link layer connection with a second access point by way of a second wireless network interface; and
determining the compatibility between the client device with an access router associated with the second access point.

2. The method of claim 1 further comprising a step of providing a client device having a plurality of transceivers.

3. The method of claim 2 further comprising a step of authenticating said client device.

4. The method of claim 1 further comprising a step of determining whether said access router supports required a functionality.

5. The method of claim 5 further comprising a step of determining whether said access router supports desired a services.

6. The method of claim 5 further comprising a step of enabling a client device to send and receive data traffic using said second wireless network interface.

7. The method of claim 6 further comprising a step of enabling the first wireless network interface to detect another access point.

8. The method of claim 5 further comprising a step of determining compatibility between the client device and an access network having the access router associated with the second access point.

9. The method of claim 1 further comprising a step of detecting when the link layer connection with the first access point is degrading.

10. The method of claim 9 wherein said step of establishing a link layer connection with a second access point comprises establishing a link layer connection with a second access point after detecting when the link layer connection with the first access point is degrading.

11. A method of connecting a client device with a router in a wireless communication network, the method comprising the steps of:
providing a client device having a plurality of transceivers;
establishing a link layer connection with a first access point by way of a first transceiver;
enabling a client device to send and receive data traffic using said first transceiver;
detecting a second access point with a second transceiver;
establishing a link layer connection with a second access point by way of said second transceiver; and
determining the compatibility between the client device with an access router associated with the second access point.

12. The method of claim 11 further comprising a step of authenticating said client device.

13. The method of claim 11 further comprising a step of determining whether said access router supports a required functionality.

14. The method of claim 13 further comprising a step of determining whether said access router supports a desired service.

15. The method of claim 14 further comprising a step of enabling the first wireless network interface to detect another access point.

16. The method of claim 11 further comprising a step of disabling the link layer connection with the second access point.

17. The method of claim 16 further comprising a step of detecting when the link layer connection with the first access point is degrading.

18. The method of claim 17 further comprising a step of establishing a link layer connection with a second access point comprises establishing a link layer connection with a second access point after detecting when the link layer connection with the first access point is degrading.

19. The method of claim 11 further comprising a step of determining compatibility between the client device and an access network having the access router associated with the second access point.

20. A method of connecting a client device with a router in a wireless communication network, the method comprising the steps of:
providing a client device having a plurality of transceivers;
establishing a link layer connection with a first access point by way of a first transceiver;
enabling a client device to send and receive data traffic using said first transceiver;
detecting a second access point with a second transceiver;
establishing a link layer connection with a second access point by way of said second transceiver; and
determining the compatibility between the client device with an access router associated with the second access point.
